(19) United States
(12) Patent Application Publication
(10) Pub. No.: US 2021/0227973 A1
(43) Pub. Date: Jul. 29, 2021

(54) FURNITURE MODULE AND READY TO ASSEMBLE FURNITURE ARTICLE COMPRISING THE FURNITURE MODULE

(71) Applicants: Jeffrey Sandberg, Vernon, CA (US); John Sandberg, Vernon, CA (US)

(72) Inventors: Jeffrey Sandberg, Vernon, CA (US); John Sandberg, Vernon, CA (US)

(21) Appl. No.: 17/157,472

(22) Filed: Jan. 25, 2021

Related U.S. Application Data
(60) Provisional application No. 62/965,088, filed on Jan. 23, 2020.

(51) Int. Cl. A47B 77/06; A47B 88/433; A47B 88/473; E03C 1/326

(52) U.S. Cl. CPC A47B 77/06; E03C 1/326; A47B 88/473; A47B 88/433

(57) ABSTRACT

A furniture article includes a furniture module and a base portion. The furniture module includes a top panel configured for direct attachment of a faucet component, and at least one side panel having a first surface and a second surface opposite from the first surface. The first surface of the at least one side panel is fixedly attached to the top panel and the second surface of the at least one side panel is free of attachments and is configured to be attached to a base portion. The base portion including at least one base panel, and the at least one base panel is configured to be attached to the second surface of the at least one side panel to form a base.

### CROSS REFERENCE TO RELATED APPLICATIONS

This application claims priority of U.S. Provisional Application No. 62/965,088 filed on Jan. 23, 2020 under 35 U.S.C. § 119(e), the entire contents of which are hereby incorporated by reference.

### BACKGROUND

### Field of Disclosure

The present invention relates to a furniture module, particularly a furniture module that can be combined with a ready to assemble furniture kit to create a furniture article, such as a bathroom vanity.

### Description of Related Art

Ready-to-assemble (RTA) furniture, also known as knock-down (KD) furniture, generally includes furniture that is packed, sold and shipped in an unassembled state. This type of furniture, after purchase and shipping, is typically assembled by the end user. Because RTA furniture is packed for sale in an unassembled state, the footprint of its packaging is greatly reduced in comparison to assembled furniture. This reduced footprint allows for easier and more cost-efficient transportation from an origin location to the purchaser. Such benefits are extremely important considering the number of sales occurring over the internet, where the purchased items must be shipped.

Regardless of the benefits of RTA furniture, not all types of furniture are typically produced in RTA form because producing some types of furniture in this form has previously been impractical and problematic. For example, bathroom vanities, which include both a top, typically made of a heavy material such as marble and configured for attachment of a faucet and a sink, and a cabinet, have not typically been offered in RTA form.

Instead, bathroom vanities have typically been sold fully assembled, with the top and the cabinet attached and the cabinet assembled. If not fully assembled, other versions of bathroom vanities have been offered where the cabinet is fully assembled but without the top plate attached. The purchaser must then obtain a top plate, if not included, and then must attach that top plate with silicon. In all of these cases, the vanity cannot be shipped via the more cost-efficient methods available for compact RTA packages. In addition, in cases where the end user must attach the top plate to the cabinet, the silicon must be allowed to cure before the vanity can be used.

Accordingly, there exists a need for an RTA vanity that can be shipped via more economical methods. Further, there exists a need for a vanity that can be shipped via these methods while providing the convenience of avoiding the delay caused while waiting of the silicon between the top and the cabinet to cure.

### SUMMARY

To address the above-discussed improvement, it is an object of the present application to provide a furniture module and ready-to-assemble furniture article comprising the furniture module.

According to the present disclosure, a furniture module includes a top panel configured for direct attachment of a faucet component, and at least one side panel having a first surface and a second surface opposite from the first surface. The first surface of the at least one side panel is fixedly attached to the top panel and the second surface of the at least one side panel is free of attachments and is configured to be attached to a base portion.

According to an embodiment of the present disclosure, the second surface of the at least one side panel is provided with a lock opening for receiving a locking pin of the base portion.

According to an embodiment of the present disclosure, the at least one side panel includes at least four side panels, and the top surfaces of the at least four side panels are fixedly attached to corresponding side portions of the top panel to form an enclosure.

According to an embodiment of the present disclosure, at least one of the at least four side panels includes a functional component.

According to an embodiment of the present disclosure, the functional component is at least one of a drawer and a hinged drawer.

According to an embodiment of the present disclosure, the faucet component includes at least one of a faucet attachment, sink and a drain attachment.

According to the present disclosure, a furniture article includes the furniture module and a base portion including at least one base panel. The at least one base panel is configured to be attached to the second surface of the at least one side panel to form a base.

According to an embodiment of the present disclosure, the at least one side panel of the top module includes at least four side panels, and the at least one base panel of the base portion includes at least back base panel, side base panels and front base panel. Top surfaces of the back base panel, side base panels and front base panel of the base portion are configured to be attached to the second surface of the at least four side panels of the top module.

According to an embodiment of the present disclosure, the at least one base panel is attached to the second surface of the at least one side panel by an attachment mechanism.

According to an embodiment of the present disclosure, the second surface of the at least one side panel of the top module is provided with a lock opening, the at least one base panel is provided with a locking pin and a latch lever, and for attaching the top module with the base portion, the locking pin is inserted into the lock opening, and the latch lever is positioned from an open position to a lock position.

According to an embodiment of the present disclosure, attachment between the back base panel and the side base panels and attachment between the side base plates and the front base panel are achieved by a slide lock mechanism.

According to an embodiment of the present disclosure, the at least one base panel includes a positioning mechanism that positions the top module.

According to an embodiment of the present disclosure, the base portion includes at least one of a drawer and a door.

### BRIEF DESCRIPTION OF THE DRAWINGS

The accompanying drawings are presented to aid in the description of embodiments of the invention and are provided solely for illustration of the embodiments and not limitation thereof.

FIG. 1 is a perspective view of a furniture article according to the present disclosure.

FIG. 2 illustrates a disassembled state of the furniture article.

FIGS. 3-9 illustrate steps for assembling the furniture article.

FIG. 10 illustrates a perspective view of an embodiment of a top module of the furniture article.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

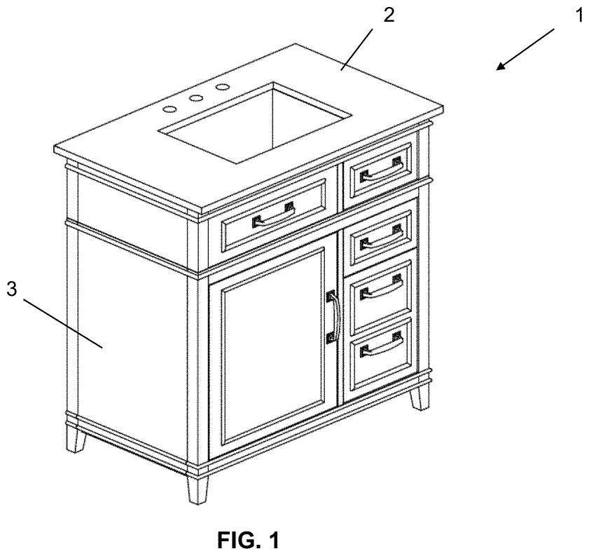

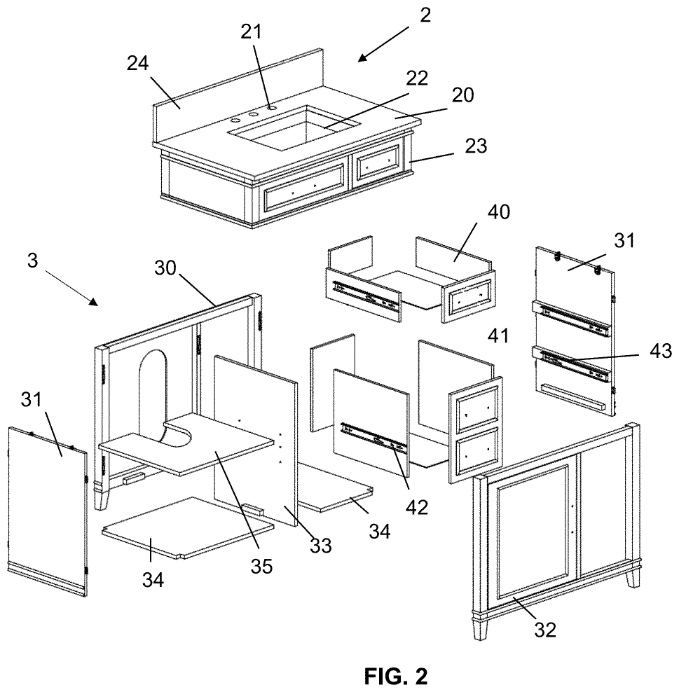

As shown in FIGS. 1 and 2, the ready-to-assemble (RTA) furniture article (hereinafter “furniture article”) 1 allows for a hybrid configuration and includes a furniture module (hereinafter “top module”) 2 and a base portion 3, which may be a cabinet. The top module 2 is the preassembled portion, which includes a top panel 20. In some embodiments, the furniture article 1 is a bathroom vanity, and the top panel 20 is a surface configured for a faucet component, such as a faucet attachment 21, a sink 22 and a drain component to be attached. The faucet component may be fixedly attached to the top panel 20 in advance or may be subsequently attached by the end user during the assembly of the furniture article 1. The top panel 20 can be made of any suitable material, such as marble, stone or engineered stone.

The top module 2 may also include at least one side panel 23. The top surface of the side panel 23 is attached to the top panel 20. Any suitable means can be used to attach the top surface of the side panel to the top panel 20, such as an adhesive, particularly silicon adhesive. The side panel 23 can instead be attached using hardware, such as screws or bolts. Additionally, the side panel 23 can be attached using multiple methods, such as a combination of hardware and adhesive. In some embodiments, the bottom surface of the side panel 23 is free of attachments and is configured to be attached to another element, such as a portion of the base portion 3, but is not attached to said element before assembly of the furniture article 1.

Additional side panels may be present, and the top panel 20 may be attached to an enclosure formed of side panels 23. The side panels 23 may include other features appropriate for the type of furniture being assembled, such as drawers, other openings for storage or a flat panel.

Moreover, a back panel 24 may optionally be included and attached to the top panel 20 as a preassembled portion of the top module 2 or can be attached during assembly of the furniture article 1. Similar to the side panels 23, the back panel 24 may be attached to the top panel 20 by any of the attachment methods discussed above.

Each of the side panels 23 is provided with an opening for receiving an attachment mechanism provided on the base portion 3 for attaching the top module 2 to the base portion 3. Any appropriate method or hardware can be used to attach the side panel 23 to the base portion 3. In some embodiments, the side panel 23 is attached to the base portion 3 using hardware, such as hardware including male and female portions. In some embodiments, the side panel 23 includes female portions and the base portion 3 includes male portions, where the male portions are inserted into the female portions and rotated into a locked portion via latches.

Alternatively, brackets may be provided onto side panel 23 and the base portion 3 for attaching the top module 2 and the base portion 3 by hardware, such as screws or bolts. Such brackets may be preattached to one of the top module 2 and the base portion 3. If the top module 2 and/or the base portion 3 is made metal, the bracket may be welded. In addition, the top module 2 and the base portion 3 may be provided with positioning mechanisms (such as dowels) for accurately positioning the top module 2 onto the base portion 3. For example, one or more openings may be provided on the bottom surface of the side panel 23 of the top module 2 for receiving dowels provided on the base portion 3 in order to accurately position the top module 2 on the base portion 3.

The size of the top module 2 may be determined based on the predetermined industrial standards or end user's preference. Alternatively, the size may depend on the shipment size requirements set forth by a shipping company. Moreover, the shape of the top module 2 may be configured depending on bathroom vanity design or to appropriately fit in the package size.

In addition, the size of the sink 22 may be determined based on the size of the top module 2. That is, the depth of the sink 22 may be less than the height of the top module 2 to make the package size of the top module 2 compact. The size the sink 22 may be determined depending on the design/style of the bathroom vanity. That is, the height, length, depth and widths can be configured as appropriate. Additionally, the shape of the sink 22, such as square, rectangular, oval, round and the like, may be selected based on the end user's needs or a configuration of the top module 2.

The base portion 3 includes at least one base panel (e.g., any one of back base panel 30, side base panels 31 and the front base panel 32). The base panel is configured to be attached to the bottom surface of the side panel 23 of the top module 2. As discussed above in relation to the side panel 23 of the top module 2, any appropriate method or hardware can be used to attach the base panel to the side panel 23. In some embodiments, the base panel is attached to the side panel 23 using hardware, such as hardware including male and female portions. In some embodiments, the side panel 23 of the top module 2 includes female portions and the at least one base panel includes male portions, where the male portions are inserted into the female portions and rotated into a locked portion via latches.

In addition to the base panel, the base portion 3 may include other panels that are attached using appropriate methods or hardware. For example, the hardware may include male and female portions locked together with latches, as described above. In addition, the hardware may include male and female portions, where the male portion is inserted into the female portion and the panels are slid relative to each other to lock the male portion into the female portion. In such a configuration, the base can be assembled without tools, and the top module can be attached to the base without tools. The base may include other elements, such as doors, shelves and leg portions.

The materials used for the panels of the module and base can be any suitable material. For example, natural woods or manufactured woods may be used. Examples of appropriate manufactured woods include MDF (medium density fiberboard) or particle board.

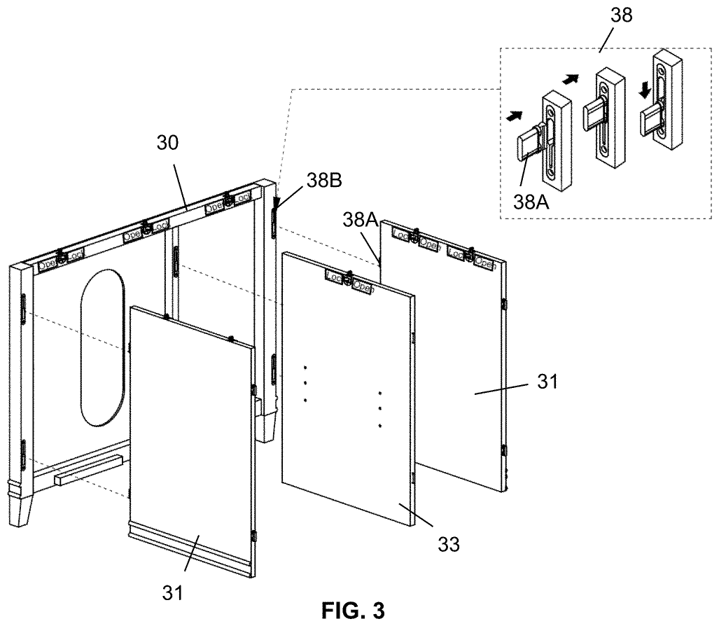

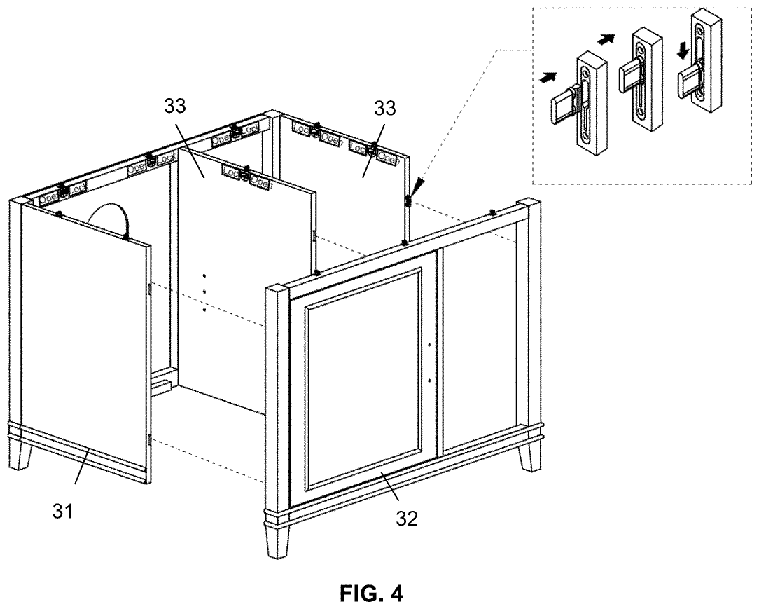

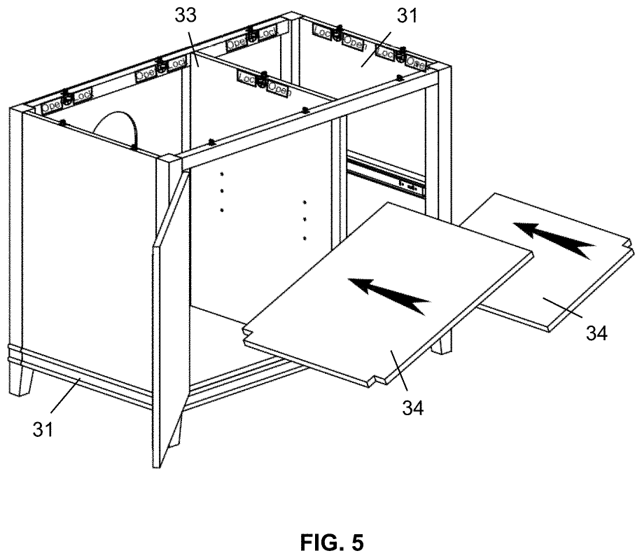

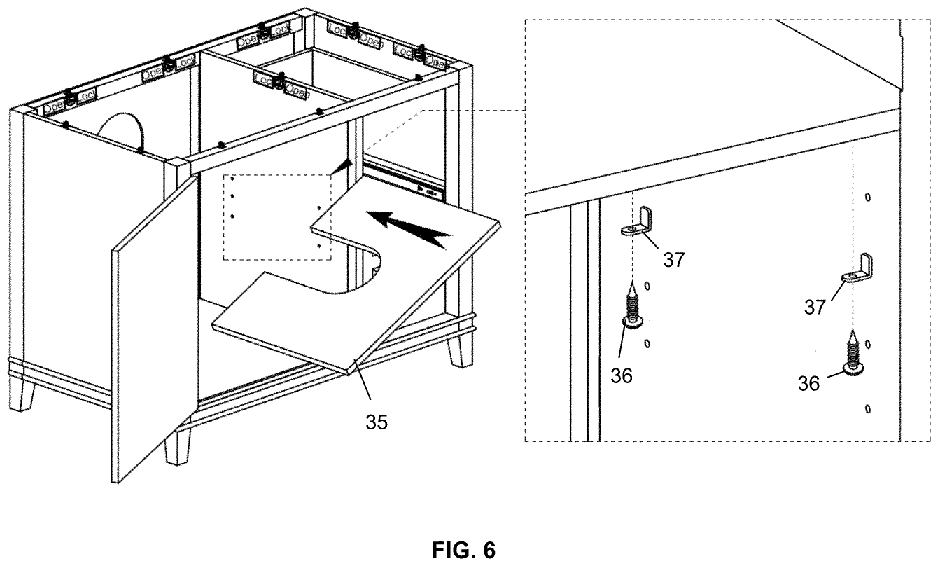

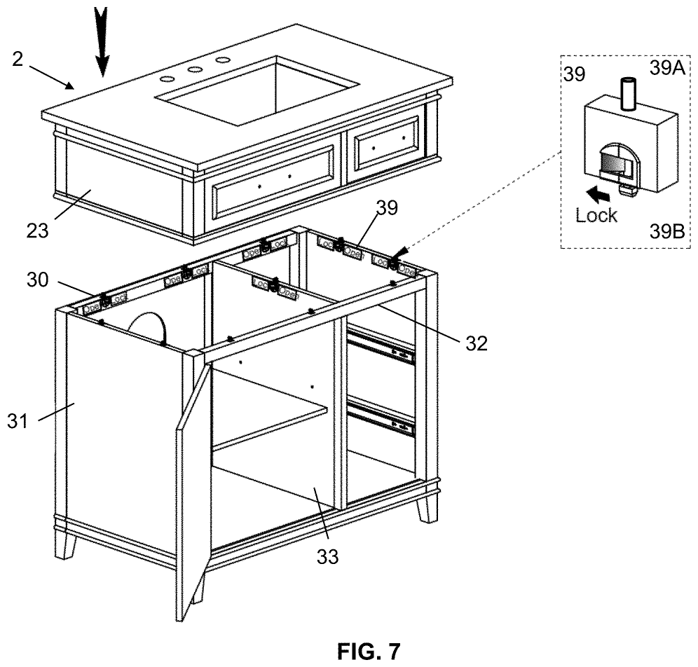

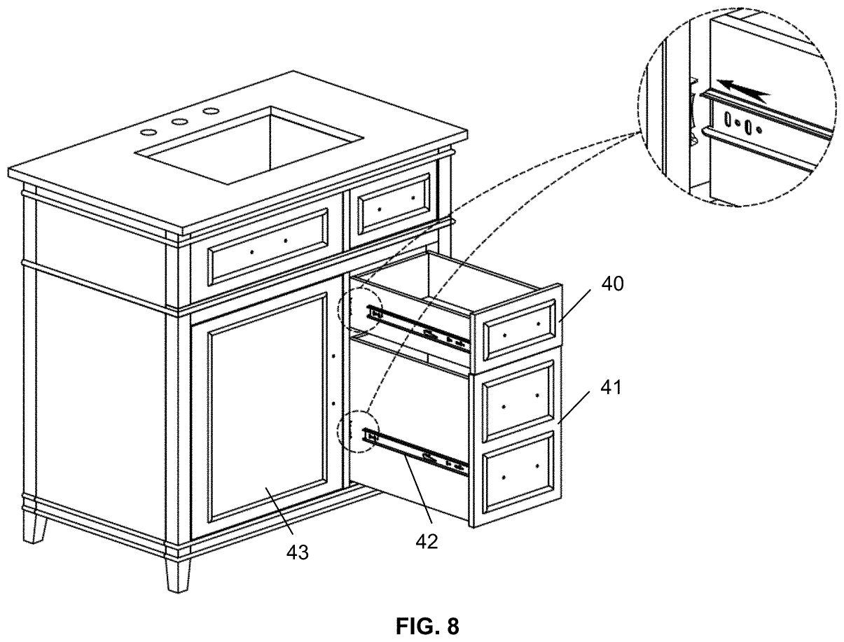

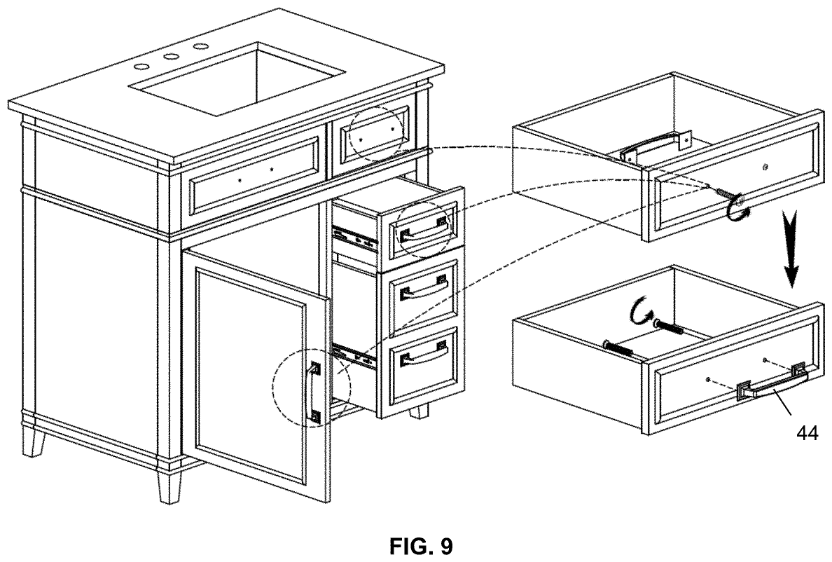

The following describes how furniture article 1 can be assembled as shown in FIGS. 3-9.

The furniture article 1 may be shipped in a single package, two packages or more packages, as necessary. In the package(s), the top module 2 and each component of the base portion 3 are included as shown in FIG. 2.

First, to assemble the base portion 3, the side base plates 31 and a middle base plate 33 are attached to the back base plate 30 by attachment mechanism. The attachment mechanism may be a sliding attachment device 38 that includes a male joint 38A and a female joint 38B. For example, the side base plate 31 is provided with the male joint 38A, and the back base plate 30 is provided with the female joint 38B. By inserting the male joint 38A into the female joint 38B and pressing down the side base plate 31, the side base plate 31 is attached and fixed to the back base plate 30. Then, the front base plate 32 is similarly attached to the side base plates 31 and the middle base plate 33.

Next, the bottom base plates 34 are inserted between the side base plates 31 and the middle base plates 33. The back base plate 30, side base plates 31, front base plate 32 and middle base plate 33 may be provided with raised edges to support the bottom base plates 34. Alternatively, support hardware may be provided to the back base plate 30, side base plates 31, front base plate 32 and middle base plate 33 to support the bottom base plate 34. In yet a further alternative, grooves may be made on the back base plate 30, side base plates 31, front base plate 32 and middle base plate 33 so that edges of the bottom base plates 34 may be inserted into the grooves. In a further alternative, instead of attaching the side base plates 31 to the back base plate 30 first, a single bottom base plate 34 may be first attached to the back base plate 30 and the front base plate 32, and then the side base plates 31 and the middle base plate 34 may be provided on the bottom base plate 34.

Then, the shelf 35 is installed inside the base portion 3 using shelfing hardware, such as screws 36 and brackets 37, at a desired height.

The top module 2 is placed on the base portion 3 by carefully aligning the side plates 23 of the top module 2 with the back base plate 30, side base plates 31, front base plate 32 and the middle base plate 33 (collectively “base plates”). If positioning mechanisms (such as dowels) are provided on one of the side plates 23 and the base plates, the positioning mechanisms are first inserted into corresponding openings provided on the other one of the side plates 23 and the base plates.

After positioning the top module 2 onto the base portion 3, the top module 2 is attached to the base portion 3 using the appropriate method or hardware discussed above. In one embodiment, locking mechanisms 39 are provided on the top surface of the base plates, and openings for receiving the locking mechanism 39 is provided on the bottom surface of the side plates 23. The locking mechanism 39 includes a locking pin 39A and a latch lever 39B. The latch lever 39B has a lock position for locking the locking pin 39A and an open position for releasing the locking pin 39A. After inserting the locking pin 39A to the opening on the side plates 23, the latch lever 39B is moved from the open position to the lock position to lock the placement of the top module 2 onto the base portion 3.

Lastly, drawers 40 and 41 may be assembled and slid onto the rails 42 provided in the base portion 3, and handles 44 are attached to the drawers 40 and 41 and the door 43. This completes the assembly of the furniture article 1.

Notably, the furniture article 1 can be assembled as described above without the need for tools to be used. Instead, the furniture article 1 can be assembled by hand.

The disclosed furniture article 1 formed by the top module 2 and the base portion 3 allows for several advantages over conventional furniture. For example, an RTA bathroom vanity kit incorporating the top module can be shipped via more economical methods. Further, the use of the top module would avoid any stress on the end user to assemble the top plate and the sink, which are often very heavy and fragile and/or any delays caused by waiting for the adhesive between the top plate and the sink or between the top plate and the side plate to cure. Finally, these benefits can be conveyed without the need for tools to assemble the top module.

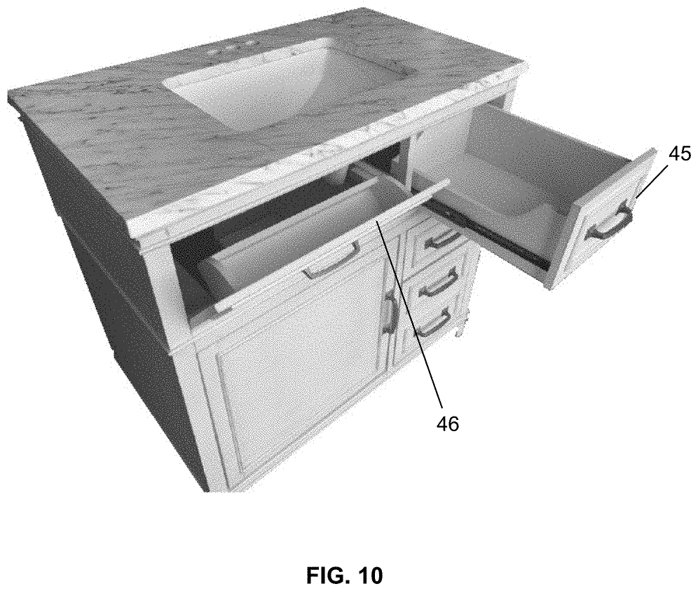

Other modification may be possible. For example, in the above embodiment, the side plates of the top module are in the form of solid plates (e.g., false drawer fronts or wooden front). However, the front side panel may be made so that functional component, such as a drawer 45 and/or hinged drawers 46 as shown in FIG. 10 may be provided. Such functional components may be preassembled in the top module or may be assembled and installed in the top module at the time of assembling the furniture article.

In addition, the seller of the furniture article 2 may provide various versions of the top module and base portions that has the same dimensions so that the customer can pick and choose different combination of the top module and the base portion.

Moreover, in the above embodiment, the furniture article was a bathroom vanity furniture. However, the invention can be applied in a kitchen faucet components or any furniture that can be made modular. For example, in a stove grill module, a stove grill can be installed in the top module.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A furniture module comprising:
a top panel configured for direct attachment of a faucet component; and
at least one side panel having a first surface and a second surface opposite from the first surface,
wherein the first surface of the at least one side panel is fixedly attached to the top panel and the second surface of the at least one side panel is free of attachments and is configured to be attached to a base portion.

2. The furniture module according to claim 1, wherein
the second surface of the at least one side panel is provided with a lock opening for receiving a locking pin of the base portion.

3. The furniture module according to claim 1, wherein
the at least one side panel includes at least four side panels, and
the top surfaces of the at least four side panels are fixedly attached to corresponding side portions of the top panel to form an enclosure.

4. The furniture module according to claim 3, wherein
at least one of the at least four side panels includes a functional component.

5. The furniture module according to claim 4, wherein
the functional component is at least one of a drawer and a hinged drawer.

6. The furniture module according to claim 1, wherein
the faucet component includes at least one of a faucet attachment, sink and a drain attachment.

7. A furniture article comprising:
the furniture module of claim 1; and
a base portion including at least one base panel,
wherein the at least one base panel is configured to be attached to the second surface of the at least one side panel to form a base.

8. The furniture article according to claim 7, wherein
the at least one side panel of the top module includes at least four side panels, and
the at least one base panel of the base portion includes at least back base panel, side base panels and front base panel, and
top surfaces of the back base panel, side base panels and front base panel of the base portion are configured to be attached to the second surface of the at least four side panels of the top module.

9. The furniture article according to claim 7, wherein
the at least one base panel is attached to the second surface of the at least one side panel by an attachment mechanism.

10. The furniture article according to claim 9, wherein
the second surface of the at least one side panel of the top module is provided with a lock opening,
the at least one base panel is provided with a locking pin and a latch lever, and
for attaching the top module with the base portion, the locking pin is inserted into the lock opening, and the latch lever is positioned from an open position to a lock position.

11. The furniture article according to claim 8, wherein
attachment between the back base panel and the side base panels and attachment between the side base plates and the front base panel are achieved by a slide lock mechanism.

12. The furniture article according to claim 7, wherein
the at least one base panel includes a positioning mechanism that positions the top module.

13. The furniture article according to claim 7, wherein
the base portion includes at least one of a drawer and a door.
